(19) United States
(12) Patent Application Publication
(10) Pub. No.: US 2018/0116777 A1
(43) Pub. Date: May 3, 2018

(54) Therapeutic Garment Assembly

(71) Applicant: Alecia Lee, Portsmouth, VA (US)

(72) Inventor: Alecia Lee, Portsmouth, VA (US)

(21) Appl. No.: 15/342,905

(22) Filed: Nov. 3, 2016

(51) Int. Cl. A61D 7/00; A61D 9/00

(52) U.S. Cl. CPC A61D 7/00; A61D 9/00

(57) ABSTRACT

A therapeutic garment assembly includes a garment that may be worn on an animal. The garment is infused with a copper material to ease joint pain. The garment is comprised of a resiliently stretchable material to facilitate compression therapy. A pair of straps is provided and each of the straps is coupled to the garment. Thus, each of the straps may be wrapped around the animal thereby retaining the garment on the animal.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art including information disclosed under 37 CFR 1.97 and 1.98

The disclosure and prior art relates to garment devices and more particularly pertains to a new garment device for providing copper therapy for an animal's joint pain.

### (h) BRIEF SUMMARY OF THE INVENTION

An embodiment of the disclosure meets the needs presented above by generally comprising a garment that may be worn on an animal. The garment is infused with a copper material to ease joint pain. The garment is comprised of a resiliently stretchable material to facilitate compression therapy. A pair of straps is provided and each of the straps is coupled to the garment. Thus, each of the straps may be wrapped around the animal thereby retaining the garment on the animal.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a back perspective view of a therapeutic garment assembly according to an embodiment of the disclosure.

FIG. 2 is a left side view of an embodiment of the disclosure.

FIG. 3 is a detail view taken from circle 3 of FIG. 2 of an embodiment of the disclosure.

FIG. 4 is a bottom view of an embodiment of the disclosure.

FIG. 5 is a perspective in-use view of an embodiment of the disclosure.

FIG. 6 is a perspective in-use view of an alternative embodiment of the disclosure.

### (j) DETAILED DESCRIPTION OF THE INVENTION

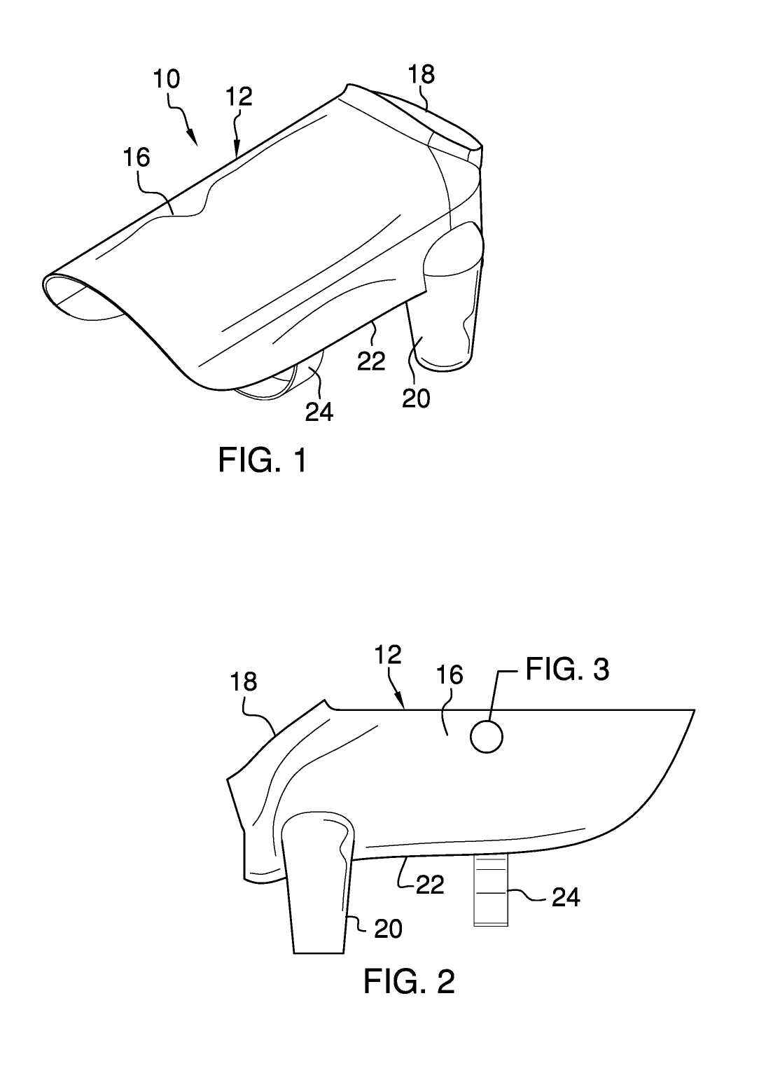

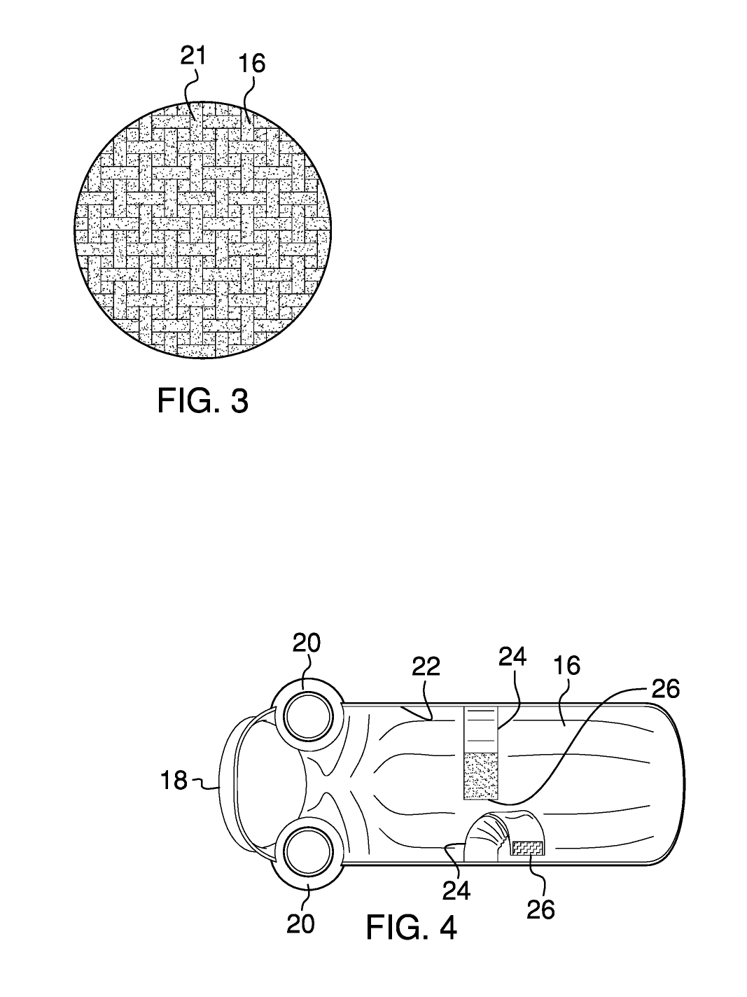

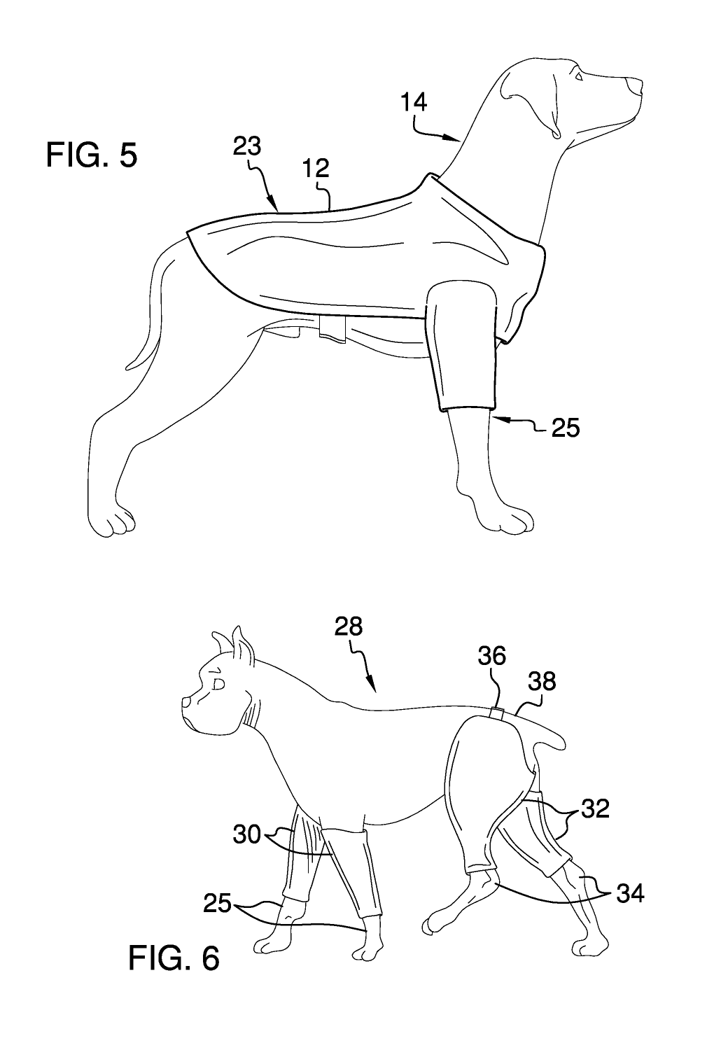

With reference now to the drawings, and in particular to FIGS. 1 through 6 thereof, a new garment device embodying the principles and concepts of an embodiment of the disclosure and generally designated by the reference numeral 10 will be described.

As best illustrated in FIGS. 1 through 6, the therapeutic garment assembly 10 generally comprises a garment 12 that may be worn on an animal 14. The animal 14 may be a dog, a cat or other domesticated animal 14. The garment 12 has a body 16, a neck 18 and a pair of sleeves 20 extending downwardly from the body 16. The body 16 has a lower edge 22 and the body 16 extends along the animal's back 23. Each of the sleeves 20 receives an associated one of the animal's front legs 25.

The garment 12 is infused with a copper material 21. The copper material 21 may be threaded copper or the like. Thus, the garment 12 eases joint pain through copper therapy. The garment 12 is comprised of a resiliently stretchable material to facilitate compression therapy. Thus, the garment 12 eases joint pain through stability and support. The joint pain may be related to arthritis or the like.

A pair of straps 24 is provided and each of the straps 24 is coupled to the garment 12. Each of the straps 24 may be wrapped around the animal 14 thereby retaining the garment 12 on the animal 14. Each of the straps 24 is positioned to extend downwardly from the lower edge 22 of the body 16. Each of the straps 24 has a distal end 26 with respect to the body 16. The distal end 26 corresponding to each of the straps 24 is matable with each other. Each of the straps 24 may include a hook and loop fastener or the like.

In an alternative embodiment 28 as shown in FIG. 6, the garment 12 may comprise a pair of front sleeves 30 and a pair of back sleeves 32. Each of the front sleeves 30 may insertably receive an associated one of the animal's front legs 25. Each of the back sleeves 32 may insertably receive an associated one of the animal's back legs 34. A strap 36 may extend between each of the back sleeves 32. The strap 36 may extend over the animal's rump 38 when the back sleeves 32 are worn.

In use, the garment 12 is worn on the animal 14 to provide therapy for joint pain. Each of the animal's front legs 25 is extended through the sleeves 20. The body 16 is positioned to extend along the animal's back 23. Each of the straps 24 is mated to retain the body 16 on the animal 14. The garment 12 compresses against the animal 14 when the garment 12 is worn. Thus, the garment 12 facilitates compression therapy for the joint pain. The copper material 21 in the garment 12 facilitates copper therapy for joint pain.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A therapeutic garment assembly being configured to be worn on an animal thereby facilitating said assembly to ease joint pain, said assembly comprising:
a garment being configured to be worn on an animal, said garment being infused with a copper material wherein said garment is configured to ease joint pain, said garment being comprised of a resiliently stretchable material wherein said garment is configured to facilitate compression therapy; and
a pair of straps, each of said straps being coupled to said garment wherein each of said straps is configured to be wrapped around the animal thereby retaining said garment on the animal.

2. The assembly according to claim 1, wherein said garment has a body, a neck and a pair of sleeves extending downwardly from said body, said body having a lower edge, said body being configured to extend along the animal's back, each of said sleeves being configured to receive an associated one of the animal's front legs.

3. The assembly according to claim 1, wherein:
said garment has a body, said body having a lower edge; and
each of said straps being positioned to extend downwardly from said lower edge of said body, each of said straps having a distal end with respect to said body, said distal end corresponding to each of said straps being matable with each other.

4. A therapeutic garment assembly being configured to be worn on an animal thereby facilitating said assembly to ease joint pain, said assembly comprising:
a garment being configured to be worn on an animal, said garment having a body, a neck and a pair of sleeves extending downwardly from said body, said body having a lower edge, said body being configured to extend along the animal's back, each of said sleeves being configured to receive an associated one of the animal's front legs, said garment being infused with a copper material wherein said garment is configured to ease joint pain, said garment being comprised of a resiliently stretchable material wherein said garment is configured to facilitate compression therapy; and
a pair of straps, each of said straps being coupled to said garment wherein each of said straps is configured to be wrapped around the animal thereby retaining said garment on the animal, each of said straps being positioned to extend downwardly from said lower edge of said body, each of said straps having a distal end with respect to said body, said distal end corresponding to each of said straps being matable with each other.
